(19) United States
(12) Patent Application Publication
(10) Pub. No.: US 2026/0299549 A1
(43) Pub. Date: Oct. 1, 2026

(54) MACHINE TOOL DISPLAY DEVICE, MACHINE TOOL CONTROL DEVICE, AND PROGRAM

(71) Applicant: FANUC CORPORATION, Minamitsuru-gun, Yamanashi (JP)

(72) Inventor: Masashi YASUDA, Minamitsuru-gun, Yamanashi (JP)

(73) Assignee: FANUC CORPORATION, Minamitsuru-gun, Yamanashi (JP)

(21) Appl. No.: 19/476,973

(22) PCT Filed: May 11, 2023
(86) PCT No.: PCT/JP2023/017813

§ 371 Date: Nov. 3, 2025

(51) Int. Cl. G05B 19/406; G05B 19/401

(52) U.S. Cl. CPC G05B 19/406; G05B 19/401; G05B 2219/36346; G05B 2219/41256; G05B 2219/45044

(57) ABSTRACT

Provided is a technology with which it is possible to easily calculate a feed rate that satisfies a target surface roughness in oscillation machining. A machine tool display device 1 is provided with: a relationship value acquisition unit 12 that acquires a relationship value indicating the relationship between the relative feed rate of a cutting tool and a workpiece and a surface roughness; a target surface roughness acquisition unit 13 that acquires a target surface roughness set for a workpiece to be machined; an oscillation condition acquisition unit 14 that acquires oscillation conditions for oscillation cutting, including at least a frequency parameter and an amplitude parameter; an oscillation feed rate calculation unit 15 that calculates a feed rate on the basis of the target surface roughness, the relationship value, and the oscillation conditions; and a display control unit 17 that displays the feed rate on a display unit.

### TECHNICAL FIELD

The present disclosure relates to a display device for a machine tool, a control device for the machine tool, and a program.

### BACKGROUND ART

Conventionally, in cutting machining, such a technique has been known that a feed rate of a main shaft that moves a workpiece that is a target of machining is designated beforehand in a machining program, for example, to perform cutting machining (for example, see Patent Documents 1 and 2).

### CITATION LIST

### Patent Document

Patent Document 1: Japanese Unexamined Patent Application, Publication No. 2003-323204
Patent Document 2: Japanese Unexamined Patent Application, Publication No. 2018-094690

### DISCLOSURE OF THE INVENTION

### Problems to be Solved by the Invention

By the way, surface roughness is used as an index for a workpiece having undergone machining. The surface roughness is determined based on a shape of a blade edge of a cutting tool and a feed rate. The surface roughness deteriorates as a feed rate increases. Furthermore, the surface roughness also changes depending on conditions for oscillation in a case of oscillation machining. However, a workpiece may be designated beforehand with desired target surface roughness, and it is necessary to determine a feed rate that satisfies the target surface roughness.

In view of the issues described above, an object of the present disclosure is to provide a technique that makes it possible to easily calculate a feed rate that satisfies target surface roughness in oscillation machining.

### Means for Solving the Problems

The present disclosure relates to a display device for a machine tool that performs oscillation machining while performing relative oscillation of a cutting tool and a workpiece, the display device including: a relationship value acquisition unit that acquires a relationship value indicating a relationship between a relative feed rate of the cutting tool and the workpiece and surface roughness; a target surface roughness acquisition unit that acquires target surface roughness that is set for the workpiece that is a target of machining; an oscillation condition acquisition unit that acquires oscillation conditions for oscillation cutting, including at least a frequency parameter and an amplitude parameter; an oscillation feed rate calculation unit that calculates a feed rate based on the target surface roughness, the relationship value, and the oscillation conditions; and a display control unit that causes a display unit to display the feed rate.

Furthermore, the present disclosure relates to a control device for a machine tool that performs oscillation machining while performing relative oscillation of a cutting tool and a workpiece, the control device including: a first feed rate acquisition unit that acquires a feed rate in non-oscillation machining that differs from the oscillation machining; a relationship value acquisition unit that acquires a relationship value indicating a relationship between a relative feed rate of the cutting tool and the workpiece and surface roughness; a target surface roughness acquisition unit that acquires target surface roughness that is set for the workpiece that is a target of machining based on the feed rate that the first feed rate acquisition unit has acquired and the relationship value; an oscillation condition acquisition unit that acquires oscillation conditions for oscillation cutting, including at least a frequency parameter and an amplitude parameter; an oscillation feed rate calculation unit that calculates a feed rate in the oscillation machining based on the target surface roughness, the relationship value, and the oscillation conditions; and a drive control unit that performs shaft control for the oscillation machining based on the feed rate in the oscillation machining.

Furthermore, the present disclosure relates to a program causing a computer for a machine tool that performs oscillation machining while performing relative oscillation of a cutting tool and a workpiece to achieve: a relationship value acquisition function of acquiring a relationship value indicating a relationship between a relative feed rate of the cutting tool and the workpiece and surface roughness; a target surface roughness acquisition function of acquiring target surface roughness that is set for the workpiece that is a target of machining; an oscillation condition acquisition function of acquiring oscillation conditions for oscillation cutting, including at least a frequency parameter and an amplitude parameter; an oscillation feed rate calculation function of calculating a feed rate based on the target surface roughness, the relationship value, and the oscillation conditions; and a display control function of causing a display unit to display the feed rate.

### BRIEF DESCRIPTION OF THE DRAWINGS

FIG. 1 is a functional block diagram of a display device for a machine tool, according to a first embodiment;

FIG. 2 is a diagram illustrating an example of a machining program;

FIG. 3 is a diagram illustrating an example of a table of tool numbers;

FIG. 4 is a flowchart illustrating an example of a flow of calculation processing for an oscillation feed rate, which the display device for the machine tool performs;

FIG. 5 is a functional block diagram of a control device for a machine tool, according to a second embodiment; and

FIG. 6 is a flowchart illustrating an example of a flow of calculation processing for an oscillation feed rate, which the control device for the machine tool performs.

### PREFERRED MODE FOR CARRYING OUT THE INVENTION

Embodiments of the present disclosure will now be described herein in detail with reference to the accompanying drawings. Note that, in below descriptions for a second embodiment and later embodiments, like reference numerals designate identical or corresponding configurations to those in a first embodiment, and their descriptions are thus appropriately omitted.

### First Embodiment

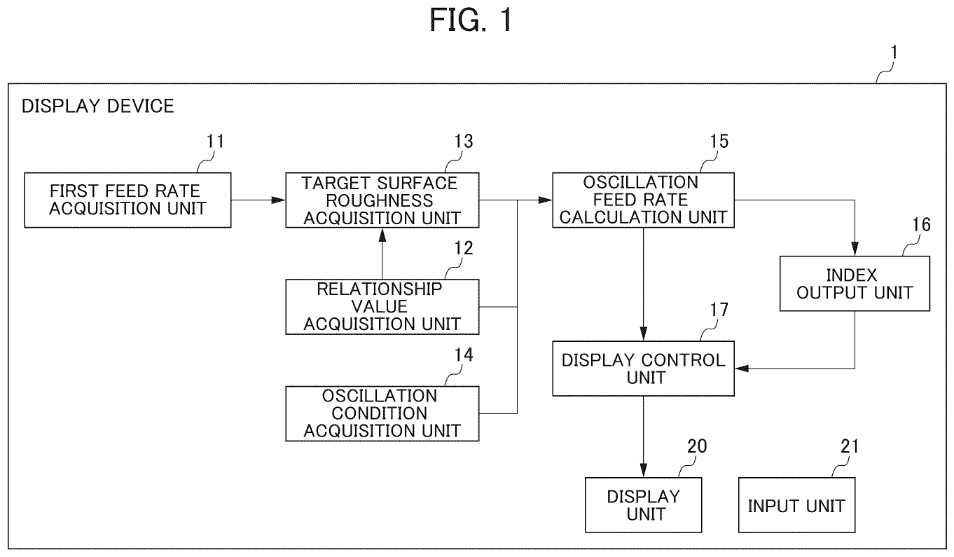

FIG. 1 is a functional block diagram of a display device 1 for a machine tool, according to a first embodiment. The display device 1 according to the first embodiment is a computer that causes a display unit 20 to display various types of information related to a machine tool that performs oscillation machining while performing relative oscillation of a cutting tool and a workpiece. The display device 1 is, for example, used and coupled to a control device that is not shown and that is a computer that controls the machine tool.

The machine tool is one that causes at least one main shaft that performs relative rotation of a cutting tool and a workpiece and at least one feed shaft that performs relative movement of the cutting tool and the workpiece to operate to allow the cutting tool to machine the workpiece. The machine tool is able to execute at least two types of machining, that is, oscillation machining in which oscillation cutting is performed and non-oscillation machining in which non-oscillation cutting is performed.

The machine tool executes various types of machining based on a machining program. The machining program includes machining conditions, for example, for a workpiece. The machining conditions for a workpiece includes, for example, a relative rotation speed of a cutting tool and the workpiece about a central axis line of the workpiece, a relative feed rate of the cutting tool and the workpiece, and a positional command for a feed shaft.

Note that, in machining that the machine tool according to the present embodiment performs, there is no limitation in shape of a workpiece. That is, applicable cases also include a case where a workpiece has a tapered portion or an arc portion on its machining surface and a plurality of feed shafts (on a Z axis and an X axis) are required and a case where a workpiece has a circular column shape or a cylindrical shape and a certain one feed shaft (on the Z axis) is sufficient.

A hardware configuration of the display device 1 for the machine tool will now be described herein. The display device 1 includes, for example, a computer including a memory including a read only memory (ROM) and a random access memory (RAM), a control processing unit (CPU), and a communication control unit, which are coupled to each other via a bus. Furthermore, the display device 1 further includes the display unit 20 that displays various types of information and an input unit 21 that an operator uses to input various types of information. The display unit 20 includes, for example, a display that displays various types of information. The input unit 21 is an operation means including, for example, a touch panel, a keyboard, and buttons.

The display device 1 for the machine tool may be configured as a computer numerical controller (CNC) or may otherwise be coupled to a higher computer (not shown) such as a CNC or a programmable logic controller (PLC). From the higher computer, machining conditions including a rotation speed, for example, in addition to a machining program, may be inputted to the display device 1 for the machine tool via the input unit 21.

Next, functional units achieved in the display device 1 will now be described herein. The display device 1 includes, as the functional units, a first feed rate acquisition unit 11, a relationship value acquisition unit 12, a target surface roughness acquisition unit 13, an oscillation condition acquisition unit 14, an oscillation feed rate calculation unit 15, an index output unit 16, and a display control unit 17. These functional units of the display device 1 are achieved as the CPU and the memory described above and a control program stored in the memory cooperate with each other.

The first feed rate acquisition unit 11 is a first feed rate calculation function of acquiring a first feed rate that is a feed rate in non-oscillation machining. The feed rate is a numerical value indicating an amount at which the cutting tool is moved. Examples of the feed rate include a feed amount per rotation (mm/rev) and a combination of a rotation number (1/min) of the main shaft and a feed rate (mm/min) of the cutting tool. In the present embodiment, the first feed rate acquisition unit 11 acquires, as the first feed rate, a feed amount (mm/rev) per one relative rotation of the cutting tool and the workpiece (one rotation of the main shaft).

The target surface roughness acquisition unit 13 is a target surface roughness calculation function of acquiring target surface roughness. The target surface roughness acquisition unit 13 may acquire the target surface roughness that the operator directly inputs on a screen via the input unit 21, may acquire the target surface roughness by referring to external data, or may acquire the target surface roughness determined separately and internally.

The relationship value acquisition unit 12 is a relationship value acquisition function of acquiring a coefficient representing a relationship value indicating a relationship between a feed rate and surface roughness. The coefficient representing the relationship between a feed rate and surface roughness is, for example, information indicating a shape of a blade edge, such as a nose R (mm) indicating a length of a diameter of the blade edge of the cutting tool.

The nose R may be one that the operator directly inputs on a display screen of the display device 1 via the input unit 21 or one that is indirectly acquired from a tool number that the operator inputs. Information corresponding to a tool number may be, for example, the nose R or a coefficient for surface roughness with respect to a feed rate acquired from an actual measurement value of a cutting tool.

Note that the relationship value that the relationship value acquisition unit 12 acquires is not limited to the nose R. For example, it may be configured that the relationship value acquisition unit 12 uses a learning model that outputs a relationship value in response to inputted information related to a tool or such a table. As described above, it may be configured that the relationship value acquisition unit 12 outputs a relationship value based on past results.

The target surface roughness is a value of desired surface roughness that is set for a workpiece that is a target of machining. Surface roughness includes at least one of, for example, arithmetic mean roughness, a maximum height that is a maximum value of a distance between a top and a bottom, a maximum top height that is a maximum value of a height from an average line of a surface, a maximum bottom depth that is an absolute value of a minimum value of the height from the average line of the surface, an average height that is an average value of the height of a contour curve element when a top and a bottom adjacent to each other are paired, a maximum cross-sectional height that is a sum of the maximum value of the height of the top and the maximum value of the depth of the bottom of the contour curve element described above, and a load length ratio that is a ratio of a load length of the contour curve element described above with respect to an evaluation reference length at a predetermined cutting level (height: % or μm). Although typical ones have been exemplified as indexes for surface roughness, the present disclosure is not limited to use these ones, but may use another index for surface roughness.

The oscillation condition acquisition unit 14 is an oscillation condition acquisition function of acquiring oscillation conditions for oscillation cutting. The oscillation conditions may be, for example, those that the operator follows those that are displayed on the display unit 20 to make an input via the input unit 21 of the display device 1 or an external computer or those automatically acquired from a machining program or set parameters for the machine tool.

The oscillation conditions at least include, as information for uniquely identifying a vibration waveform, a parameter of frequency, which is information related to an oscillation frequency of a cutting tool or a workpiece, and a parameter of amplitude, which is information related to oscillation amplitude of the cutting tool or the workpiece. The frequency parameter may be a number of vibrations per one relative rotation of the cutting tool and the workpiece or a number of vibrations per unit period of time. Furthermore, a cycle parameter of forward-and-rearward movement operation may be used. The amplitude parameter may be information related to oscillation amplitude with respect to a feed amount per one relative rotation of the cutting tool and the workpiece or a distance parameter of forward-and-rearward movement operation. The cycle parameter of forward-and-rearward movement operation and the distance parameter of forward-and-rearward movement operation may be determined from, for example, a forward-movement speed, a backward-movement speed, a forward-movement distance, a backward-movement distance, a rotation number of the main shaft, and a control cycle. The frequency parameter and the amplitude parameter may be determined from, for example, a rotation number of the main shaft, a feed rate per rotation, a feed rate per minute, a frequency multiplying factor that is a number of vibrations per one relative rotation of the cutting tool and the workpiece, and an amplitude multiplying factor that is oscillation amplitude with respect to a feed amount per one relative rotation of the cutting tool and the workpiece.

In the present embodiment, as the parameter of frequency, an oscillation frequency multiplying factor I (times) indicating an oscillation frequency per one rotation of the main shaft is used. The oscillation frequency multiplying factor I (times) may be directly designated or may be calculated, after an oscillation frequency (Hz) is designated, from the oscillation frequency (Hz) and a rotation number S (1/min) of the main shaft.

Furthermore, as the parameter of amplitude, an oscillation amplitude multiplying factor K (times) indicating a magnitude of oscillation amplitude with respect to a magnitude of a feed amount per one rotation of the main shaft is used. Furthermore, the oscillation amplitude multiplying factor K (times) may also be directly designated.

The oscillation feed rate calculation unit 15 is an oscillation feed rate calculation function of calculating a feed rate for oscillation cutting based on the target surface roughness that the target surface roughness acquisition unit 13 has acquired, the coefficient that the relationship value acquisition unit 12 has acquired, and the oscillation conditions that the oscillation condition acquisition unit has acquired.

The index output unit 16 is an index output function of outputting an index indicating a degree of change from the feed rate in oscillation machining to the feed rate in non-oscillation machining. The index output unit 16 calculates, in a numerical value, for example, a ratio between the feed rate in oscillation machining and the feed rate in non-oscillation machining. Note that the index output unit 16 may use another calculation method to calculate an index indicating a degree of change or may use text or a symbol to express an index to allow a degree of change to be distinguished.

The display control unit 17 is a display control function of causing the display unit 20 to display various types of information related to the display device 1 and information with respect to a result of an input that the operator has provided. The display control unit 17 according to the present embodiment also executes processing of displaying a result of calculation of the oscillation feed rate calculation unit 15 and a result of output of the index output unit 16.

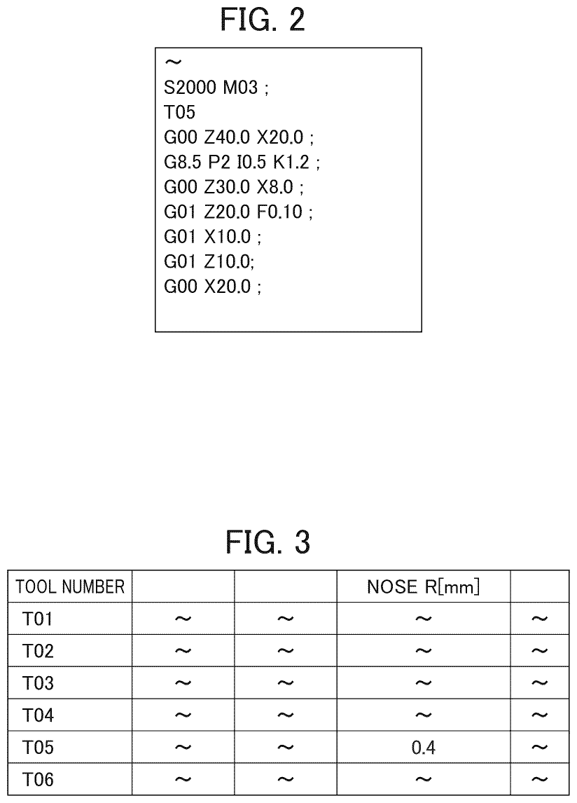

Next, calculation processing for an oscillation speed, which the display device 1 performs, will now be described herein. FIG. 2 is a diagram illustrating an example of a machining program.

In the machining program illustrated in FIG. 2, the block “S2000 M03” is a description indicating that the main shaft is to be positively rotated. The block “T05” is a description indicating a tool number that is information for identifying tool surface roughness degree information. The blocks starting from “G00” such as “G00 Z40.0 X20.0” and “G01” are descriptions each indicating a behavior such as positioning or linear interpolation or coordinates. The description “G8.5 P2” is a criterion indicating that an oscillation mode is to be turned ON, and, in the identical block, the next description “I0.5” is an I command indicating that a frequency multiplying factor is 0.5 times and the next description “K1.2” is a K command indicating that an amplitude multiplying factor is 1.2 times.

Next, an example where a tool number is set as a coefficient will now be described herein. FIG. 3 is a diagram illustrating an example of a table of tool numbers. In the example illustrated in FIG. 3, pieces of information of at least tool numbers T01 to T06 and the noses R respectively corresponding to tool numbers T01 to T06 are stored in a table format.

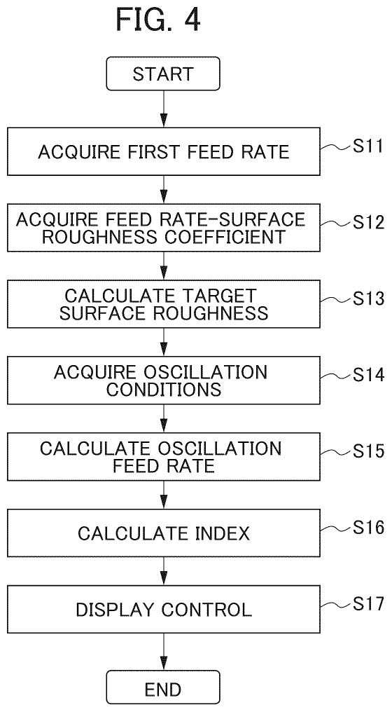

Next, with reference to FIG. 4, a flow of calculation processing for an oscillation feed rate when the machining program illustrated in FIG. 2 and the table of tool numbers illustrated in FIG. 3 are set will now be described herein. FIG. 4 is a flowchart illustrating an example of the flow of the calculation processing for an oscillation feed rate, which the display device 1 performs. Note that the order and the content of the processing illustrated in the flowchart are mere examples, and it is possible to appropriately change the order and the content of the processing.

The first feed rate acquisition unit 11 first acquires a feed rate in non-oscillation machining from a machining program (Step S11). In the example illustrated in FIG. 2, a feed rate of 0.10 [mm/rev] is acquired from an F command.

Next, the relationship value acquisition unit 12 acquires a nose R as a feed rate-surface roughness coefficient (Step S12). In the example illustrated in FIG. 2, the relationship value acquisition unit 12 acquires a nose R of 0.4 (mm) corresponding to the tool number “T05” included in the machining program, that is, the relationship value acquisition unit 12 acquires a coefficient of feed rate-surface roughness.

The target surface roughness acquisition unit 13 calculates target surface roughness based on the first feed rate that the first feed rate acquisition unit 11 has calculated and the coefficient that the relationship value acquisition unit 12 has acquired (Step S13).

The target surface roughness acquisition unit 13 substitutes the first feed rate and the nose R for those in Mathematical Equation 1 described below, for example, to acquire target surface roughness. In Mathematical Equation (1), h represents target surface roughness Rz (μm), f represents a feed amount per one rotation of the main shaft (mm/rev), and RE represents a nose R (mm) of a corner radius of an insert, which serves as information indicating a shape of a blade edge of a cutting tool T.

$$\begin{matrix}[ Mathematical Equation 1 ] & \\ & Mathematical Equation ( 1 )\end{matrix}$$

$$h = \frac{{f}^{2}}{8 RE} \times 1000 ( μ m )$$

When the feed rate of 0.1 [mm/rev] is substituted for f in Mathematical Equation (1), and the nose R [mm] is substituted for RE, it is possible to calculate target surface roughness Rz serving as theoretical surface roughness as described in Mathematical Equation (2) below.

$$\begin{matrix}[ Mathematical Equation 2 ] & \\ & Mathematical Equation ( 2 )\end{matrix}$$

$${( 0.1 )}^{2} / ( 8 \times 0.4 ) \times 1000 = 3.125 [ μ m ]$$

Next, the oscillation condition acquisition unit 14 acquires oscillation conditions from the machining program (Step S14). In the example illustrated in FIG. 2, the oscillation condition acquisition unit 14 acquires a frequency multiplying factor of 0.5 times from “I0.5”, and acquires an amplitude multiplying factor of 1.2 times from “K1.2”.

Next, the oscillation feed rate calculation unit 15 calculates a feed rate in oscillation machining based on the target surface roughness that the target surface roughness acquisition unit 13 has acquired, the coefficient of feed rate-surface roughness that the relationship value acquisition unit 12 has acquired, and the oscillation conditions that the oscillation condition acquisition unit 14 has acquired (Step S15).

The oscillation feed rate calculation unit 15 first calculates, as a compensation coefficient, a degree of change in surface roughness in oscillation machining with respect to non-oscillation machining based on the oscillation conditions. For setting a compensation coefficient, a compensation coefficient is set as a surface roughness changing coefficient based on result data of degrees of change when machining is actually performed, that is, non-oscillation machining and oscillation machining are respectively actually performed. For example, a compensation coefficient is determined as a frequency multiplying factor and an amplitude multiplying factor that are oscillation conditions are inputted in a table based on the result data or Mathematical Equations. In the example illustrated in FIG. 2, it is assumed that a compensation coefficient of 2.0 is set as a surface roughness changing coefficient in accordance with the oscillation conditions based on the frequency multiplying factor of 0.5 times and the amplitude multiplying factor of 1.2 times.

Next, the oscillation feed rate calculation unit 15 inputs, in Mathematical Equation 1, the target surface roughness Rz [μm] and the nose R [mm] in RE, and performs a multiplication with the compensation coefficient of 2. In the examples illustrated in FIGS. 2 and 3, Mathematical Equation 3 described below is established. The oscillation feed rate calculation unit 15 solves Mathematical Equation (3) to calculate a feed rate of F≈(symbol indicating approximately equal) 0.071 [mm/rev].

$$\begin{matrix}[ Mathematical Equation 3 ] & \\ & Mathematical Equation ( 3 )\end{matrix}$$

$$3.125 = ( feed rate {F}^{2} / ( 8 \times 0.4 ) \times 1000 ) \times 2$$

Although, in the example described above, a compensation coefficient achieving a degree of change in surface roughness in oscillation machining with respect to non-oscillation machining has been acquired to calculate an oscillation feed rate, the present disclosure is not limited to this example, and, for example, such an algorithm that performs numerical value calculation to calculate, based on a cutting path that is calculated based on oscillation conditions and an oscillation feed rate and a nose R, surface roughness in oscillation cutting, and that searches and retrieves an oscillation feed rate at which the surface roughness in the oscillation cutting coincides with target surface roughness may be used to calculate an oscillation feed rate.

Furthermore, there is a deviation between surface roughness based on a theoretical value and surface roughness acquired when machining is actually performed. Then, in calculation of an oscillation feed rate, a margin for allowing surface roughness acquired through machining using oscillation cutting to be equivalent to or higher than surface roughness acquired through machining using non-oscillation cutting may be set beforehand using a parameter, and an oscillation feed rate that is reduced by this margin may be calculated.

Furthermore, although, in the example described above, an oscillation feed rate that achieves target surface roughness has been calculated, it is not necessary to always reach achievement, and, when desired surface roughness has an allowable error, for example, such a calculation method for an oscillation feed rate, which satisfies the desired surface roughness, may be applied.

Next, the index output unit 16 calculates, in a numerical value, a ratio between the feed rate in oscillation machining and the feed rate in non-oscillation machining (Step S16).

Next, the display control unit 17 executes display control for causing the display unit 20 to display the feed rate for oscillation cutting, which the oscillation feed rate calculation unit 15 has calculated, and the index (Step S17). In the examples illustrated in FIGS. 2 and 3, the display control unit 17 executes processing of displaying, on the display screen, the feed rate of F=0.071 [mm/rev] and the ratio between the feed rate in oscillation machining and the feed rate in non-oscillation machining. Thereby, the operator changing the designation of F=0.10 on the machining program to F=0.071 is able to acquire, even when oscillation machining is to be performed, surface roughness equivalent to surface roughness acquired with F=0.10 in non-oscillation machining.

With the display device 1 for the machine tool that performs oscillation machining while performing relative oscillation of a cutting tool and a workpiece, according to the first embodiment, it is possible to achieve effects described below.

The display device 1 for the machine tool, according to the present embodiment, includes: the relationship value acquisition unit 12 that acquires a relationship value indicating a relationship between a relative feed rate of a cutting tool and a workpiece and surface roughness; the target surface roughness acquisition unit 13 that acquires target surface roughness that is set for the workpiece that is a target of machining; the oscillation condition acquisition unit 14 that acquires oscillation conditions for oscillation cutting, including at least a frequency parameter and an amplitude parameter; the oscillation feed rate calculation unit 15 that calculates a feed rate achieving target surface roughness based on the target surface roughness, the relationship value, and the oscillation conditions; and the display control unit 17 that causes the display unit to display the feed rate.

Thereby, even when a feed rate for oscillation machining has not yet been designated beforehand with a machining program, for example, a feed rate is automatically calculated based on desired target surface roughness.

Furthermore, in the present embodiment, the first feed rate acquisition unit 11 that acquires a feed rate in non-oscillation machining that differs from oscillation machining is further included, and the target surface roughness acquisition unit 13 calculates target surface roughness based on the feed rate that the first feed rate acquisition unit 11 has acquired and the relationship value. Thereby, it is possible to easily calculate a feed rate for oscillation machining, which makes it possible to achieve, in oscillation machining, equivalent surface roughness to that in non-oscillation machining. Although there is a deviation as an absolute value, there is a mutual relationship between a theoretical value of surface roughness, which is acquired through calculation, and an actual value of surface roughness, which is acquired through actual machining. According to the present embodiment, the operator is able to utilize, without being aware of an absolute value of surface roughness, such a mutual relationship as described above to calculate a feed rate for oscillation machining, which makes it possible to achieve equivalent surface roughness to that in non-oscillation cutting.

Furthermore, in the display device 1 according to the present embodiment, the index output unit 16 that calculates an index indicating a degree of change between a feed rate in oscillation machining and a feed rate in non-oscillation machining is further included, and the display control unit 17 causes the display unit 20 to display the index. Thereby, the operator is able to more easily know, with the index, a degree of change in feed rate when non-oscillation machining is changed to oscillation machining in accordance with the index.

Furthermore, in the present embodiment, the relationship value is set based on nose information indicating a shape of a blade edge of the cutting tool. Thereby, a length of the nose is set as a relationship value, making it possible to easily calculate a feed rate in oscillation machining without performing complex processing.

The embodiment of the display device 1 has been described above. For example, the first feed rate acquisition unit 11 may be omitted from the configuration of the display device 1 according to the embodiment described above, and the target surface roughness acquisition unit 13 may acquire target surface roughness in accordance with a machining program or an input of the operator. Furthermore, the index output unit 16 may be omitted, and displaying of an index on the display unit 20 may be omitted.

### Second Embodiment

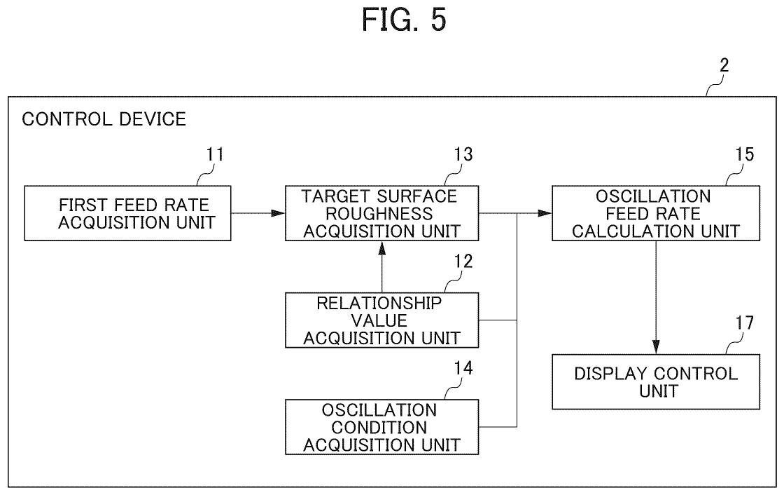

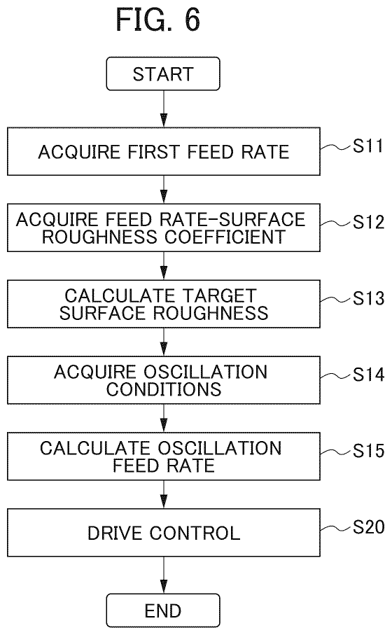

Next, a control device 2 for a machine tool will now be described herein with reference to FIGS. 5 and 6. FIG. 5 is a functional block diagram of the control device 2 for the machine tool, according to the second embodiment. FIG. 6 is a flowchart illustrating an example of a flow of calculation processing for an oscillation feed rate, which the control device 2 performs.

The control device 2 according to the second embodiment is a computer that controls the machine tool that performs machining while performing relative movement of a cutting tool and a workpiece. The machine tool is similar or identical in configuration to the machine tool according to the first embodiment.

The control device 2 for the machine tool includes, for example, a computer having a display screen, which includes a memory including a ROM and a RAM, a CPU, a communication control unit, and a display, which are coupled to each other via a bus. The control device 2 for the machine tool may be configured as a CNC or may otherwise be coupled to a higher computer (not shown) such as a CNC or a PLC. From the higher computer, machining conditions including a rotation speed, for example, in addition to a machining program, may be inputted to the control device 2 for the machine tool.

The control device 2 includes, as functional units, the first feed rate acquisition unit 11, the relationship value acquisition unit 12, the target surface roughness acquisition unit 13, the oscillation condition acquisition unit 14, the oscillation feed rate calculation unit 15, and a drive control unit 30. These functional units of the control device 2 are achieved as the CPU and the memory described above and a control program stored in the memory cooperate with each other.

In the configuration of the control device 2, the first feed rate acquisition unit 11, the target surface roughness acquisition unit 13, the relationship value acquisition unit 12, the oscillation condition acquisition unit 14, and the oscillation feed rate calculation unit 15 are similar or identical to those in the configuration according to the first embodiment, and their detailed descriptions will be omitted. Furthermore, in the flowchart illustrated in FIG. 6, Steps S11 to S15 are similar or identical to Steps S11 to S15 in the flowchart illustrated in FIG. 4 in the first embodiment, and their detailed descriptions will be omitted.

The drive control unit 30 that is a different component from those in the configuration of the first embodiment will now be described herein. The drive control unit 30 is a drive control function of performing shaft control on a feed shaft for oscillation machining based on a feed rate in oscillation machining. Thereby, it is possible to easily calculate a feed rate for oscillation machining, which makes it possible to achieve, in oscillation machining, equivalent surface roughness to that in non-oscillation machining. Although there is a deviation as an absolute value, there is a mutual relationship between a theoretical value of surface roughness, which is acquired through calculation, and an actual value of surface roughness, which is acquired through actual machining. According to the present embodiment, the operator is able to utilize, without being aware of an absolute value of surface roughness, such a mutual relationship as described above to calculate a feed rate for oscillation machining, which makes it possible to achieve equivalent surface roughness to that in non-oscillation cutting.

In the flowchart illustrated in FIG. 6, after Steps S11 to S15 in the processing have been executed, the processing proceeds to Step S20 at which the drive control unit 30 executes the shaft control. The drive control unit 30 executes, when non-oscillation machining among non-oscillation machining and oscillation machining is determined to be executed, shaft control based on the feed rate that the first feed rate acquisition unit 11 has acquired and executes, when oscillation machining is determined to be executed, shaft control based on a feed rate that the oscillation feed rate calculation unit 15 has calculated (Step S20). Thereby, even when a feed rate for non-oscillation machining has only been set, a feed rate in oscillation machining is automatically set to achieve equivalent target surface roughness to that in non-oscillation machining, further making it possible to provide convenience.

Note that the present disclosure is not limited to the embodiments described above, and the present disclosure still includes amendments and modifications, for example, that fall within the scope of the present disclosure, as long as it is possible to achieve the object of the present disclosure.

Regarding the embodiments described above and modification examples, notes described below are further disclosed.

### Note 1

A display device (1) for a machine tool that performs oscillation machining while performing relative oscillation of a cutting tool and a workpiece, the display device (1) including:
a relationship value acquisition unit (12) that acquires a relationship value indicating a relationship between a relative feed rate of the cutting tool and the workpiece and surface roughness;
a target surface roughness acquisition unit (13) that acquires target surface roughness that is set for the workpiece that is a target of machining;
an oscillation condition acquisition unit (14) that acquires oscillation conditions for oscillation cutting, including at least a frequency parameter and an amplitude parameter; an oscillation feed rate calculation unit (15) that calculates a feed rate based on the target surface roughness, the relationship value, and the oscillation conditions; and
a display control unit (17) that causes a display unit (20) to display the feed rate.

### Note 2

In the display device (1) described above, a first feed rate acquisition unit (11) that acquires a feed rate in non-oscillation machining that differs from the oscillation machining is further included, and
the target surface roughness acquisition unit (13) calculates the target surface roughness based on the feed rate that the first feed rate acquisition unit has acquired and the relationship value.

### Note 3

In the display device (1) described above, an index output unit (16) that calculates an index indicating a degree of change between a feed rate in the oscillation machining and a feed rate in the non-oscillation machining is further included, and
the display control unit (17) causes the display unit (20) to display the index.

### Note 4

In the display device (1) described above, the relationship value is set based on nose information indicating a shape of a blade edge of the cutting tool.

### Note 5

A control device (2) for a machine tool that performs oscillation machining while performing relative oscillation of a cutting tool and a workpiece, the control device (2) including:
a first feed rate acquisition unit (11) that acquires a feed rate in non-oscillation machining that differs from the oscillation machining;
a relationship value acquisition unit (12) that acquires a relationship value indicating a relationship between a relative feed rate of the cutting tool and the workpiece and surface roughness;
a target surface roughness acquisition unit (13) that acquires target surface roughness that is set for the workpiece that is a target of machining based on the feed rate that the first feed rate acquisition unit has acquired and the relationship value;
an oscillation condition acquisition unit (14) that acquires oscillation conditions for oscillation cutting, including at least a frequency parameter and an amplitude parameter;
an oscillation feed rate calculation unit (15) that calculates a feed rate in the oscillation machining based on the target surface roughness, the relationship value, and the oscillation conditions; and
a drive control unit (30) that performs shaft control for the oscillation machining based on the feed rate in the oscillation machining.

### Note 6

In the control device (2) described above, the drive control unit (30)
executes, when the non-oscillation machining among the non-oscillation machining and the oscillation machining is determined to be executed, shaft control based on the feed rate that the first feed rate acquisition unit has acquired, and
executes, when the oscillation machining is determined to be executed, shaft control based on the feed rate that the oscillation feed rate calculation unit (15) has calculated.

### Note 7

A program causing a computer for a machine tool that performs oscillation machining while performing relative oscillation of a cutting tool and a workpiece to achieve:
a relationship value acquisition function of acquiring a relationship value indicating a relationship between a relative feed rate of the cutting tool and the workpiece and surface roughness;
a target surface roughness acquisition function of acquiring target surface roughness that is set for the workpiece that is a target of machining;
an oscillation condition acquisition function of acquiring oscillation conditions for oscillation cutting, including at least a frequency parameter and an amplitude parameter;
an oscillation feed rate calculation function of calculating a feed rate based on the target surface roughness, the relationship value, and the oscillation conditions; and
a display control function of causing a display unit (20) to display the feed rate.

### Note 8

In the program described above,
the computer is further caused to achieve a first feed rate acquisition function of acquiring a feed rate in non-oscillation machining that differs from the oscillation machining, and
the target surface roughness acquisition function calculates the target surface roughness based on the feed rate that the first feed rate acquisition function has acquired and the relationship value.

### EXPLANATION OF REFERENCE NUMERALS

1 Display device for machine tool
2 Control device for machine tool
11 First feed rate acquisition unit
12 Relationship value acquisition unit
13 Target surface roughness acquisition unit
14 Oscillation condition acquisition unit
15 Oscillation feed rate calculation unit
16 Index output unit
17 Display control unit
20 Display unit
30 Drive control unit

1. A display device for a machine tool that performs oscillation machining while performing relative oscillation of a cutting tool and a workpiece, the display device comprising:
a relationship value acquisition unit that acquires a relationship value indicating a relationship between a relative feed rate of the cutting tool and the workpiece and surface roughness;
a target surface roughness acquisition unit that acquires target surface roughness that is set for the workpiece that is a target of machining;
an oscillation condition acquisition unit that acquires oscillation conditions for oscillation cutting, including at least a frequency parameter and an amplitude parameter;
an oscillation feed rate calculation unit that calculates a feed rate based on the target surface roughness, the relationship value, and the oscillation conditions; and
a display control unit that causes a display unit to display the feed rate.

2. The display device for the machine tool, according to claim 1,
further comprising a first feed rate acquisition unit that acquires a feed rate in non-oscillation machining that differs from the oscillation machining,
wherein the target surface roughness acquisition unit calculates the target surface roughness based on the feed rate that the first feed rate acquisition unit has acquired and the relationship value.

3. The display device for the machine tool, according to claim 2,
further comprising an index output unit that calculates an index indicating a degree of change between a feed rate in the oscillation machining and a feed rate in the non-oscillation machining,
wherein the display control unit causes the display unit to display the index.

4. The display device for the machine tool, according to claim 1, wherein the relationship value is set based on nose information indicating a shape of a blade edge of the cutting tool.

5. A control device for a machine tool that performs oscillation machining while performing relative oscillation of a cutting tool and a workpiece, the control device comprising:
a first feed rate acquisition unit that acquires a feed rate in non-oscillation machining that differs from the oscillation machining;
a relationship value acquisition unit that acquires a relationship value indicating a relationship between a relative feed rate of the cutting tool and the workpiece and surface roughness;
a target surface roughness acquisition unit that acquires target surface roughness that is set for the workpiece that is a target of machining based on the feed rate that the first feed rate acquisition unit has acquired and the relationship value;
an oscillation condition acquisition unit that acquires oscillation conditions for oscillation cutting, including at least a frequency parameter and an amplitude parameter;
an oscillation feed rate calculation unit that calculates a feed rate in the oscillation machining based on the target surface roughness, the relationship value, and the oscillation conditions; and
a drive control unit that performs shaft control for the oscillation machining based on the feed rate in the oscillation machining.

6. The control device for the machine tool, according to claim 5, wherein the drive control unit
executes, when the non-oscillation machining among the non-oscillation machining and the oscillation machining is determined to be executed, shaft control based on the feed rate that the first feed rate acquisition unit has acquired, and
executes, when the oscillation machining is determined to be executed, shaft control based on the feed rate that the oscillation feed rate calculation unit has calculated.

7. A readable storage medium storing a program causing a computer for a machine tool that performs oscillation machining while performing relative oscillation of a cutting tool and a workpiece to achieve functions comprising:
a relationship value acquisition function of acquiring a relationship value indicating a relationship between a relative feed rate of the cutting tool and the workpiece and surface roughness;
a target surface roughness acquisition function of acquiring target surface roughness that is set for the workpiece that is a target of machining;
an oscillation condition acquisition function of acquiring oscillation conditions for oscillation cutting, including at least a frequency parameter and an amplitude parameter;
an oscillation feed rate calculation function of calculating a feed rate based on the target surface roughness, the relationship value, and the oscillation conditions; and
a display control function of causing a display unit to display the feed rate.

8. The readable storage medium storing a program according to claim 7, wherein
the computer is further caused to achieve a first feed rate acquisition function of acquiring a feed rate in non-oscillation machining that differs from the oscillation machining, and
the target surface roughness acquisition function calculates the target surface roughness based on the feed rate that the first feed rate acquisition function has acquired and the relationship value.
